(19) United States
(12) Patent Application Publication
(10) Pub. No.: US 2005/0091266 A1
(43) Pub. Date: Apr. 28, 2005

(54) Data file system, data access server and data access program storage medium

(75) Inventor: Takahiro Hasegawa, Shizuoka (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/816,916

(22) Filed: Apr. 5, 2004

(30) Foreign Application Priority Data
Oct. 23, 2003 (JP) 2003-363395

(51) Int. Cl. G06F 17/00

(52) U.S. Cl. 707/103 R

(57) ABSTRACT

The present invention relates to a data file system having: a data access server that has a physical storage for storing data and accesses the physical storage in response to an access request; and a data file server that performs data filing by transmitting an access request to the data access server and using the data access server for data saving. When a logical block becomes unused, the physical block associated with the logical block is effectively released. For example, data backup software that accesses all the physical blocks being used within a predetermined time is activated to search through logical blocks assigned respective physical blocks for a logical block for which no access request is made within the predetermined time during which the data backup software runs. The physical block associated with the logical block is released from the association and included in unused physical blocks.

### BACKGROUND OF THE INVENTION

1. Field of the Invention

The present invention relates to a data file system having a data access server that has a physical storage for storing data and accesses the physical storage in response to an access request and a data file server that performs data filing by transmitting an access request to the data access server and using the data access server for data saving, the data access server of the data file system, and a data access program storage medium that stores a data access program that makes an information processing device operate as such a data access server.

2. Description of the Related Art

According to a method of implementing a virtual storage system (virtual disk), a data file server for performing data filing realizes a virtual disk having no physical storage entity and assigns a physical storage region to a part (region) of the virtual disk which is accessed by the data file server. This method has an advantage that wasted storage area can be reduced because an actually required volume of physical storage may be prepared when it is required.

FIG. 1 is a diagram illustrating the method of implementing a virtual storage system described above.

Part (A) of FIG. 1 shows a state of a data file server that performs data filing, and parts (B) and (C) of FIG. 1 show states of a data access server that accesses a physical storage in response to an access request from the data file server.

In the shown example, the data access server has the physical storage which has a storage capacity of 10 GB. The physical storage is divided into plural storage blocks having a predetermined storage capacity. The storage block in the physical storage is referred to as a physical block herein.

The data access server has a virtual storage system shown in part (B) of FIG. 1 mounted thereon, and the virtual storage system has a bulk virtual disk having a capacity of 500 GB and an address translation table for translating the addresses of the storage blocks in the virtual storage into the addresses of the storage blocks in the physical storage having a capacity of 10 GB shown in part (C) of FIG. 1 and vice versa.

The data file server recognizes that the data access server has the 500 GB bulk storage disk (virtual disk) as shown in part (A) of FIG. 1. The storage blocks recognized by the data file server are referred to as logical blocks herein.

In such an environment, if the data file server transmits to the data access server a request to write a predetermined storage block of the 500 GB storage disk (virtual disk), the address translation table in the virtual storage system of the data access server (part (B) of FIG. 1) is referred to and the address of the storage block (logical block) for which the write request is transmitted from the data file server is translated into the address of a storage block (physical block) of the physical storage. If no physical block is assigned to the logical block concerned with the write request, an unused physical block is assigned to the logical block. In the virtual storage system, the address of the physical block is determined by address translation in this way, and the data access server writes data to the physical block thus determined in the physical storage. Data reading from the physical storage is conducted in the same way.

Such a virtual storage system allows a virtual bulk storage disk that exceeds the actual physical storage in capacity to be created. If the data file server recognizes the storage capacity of 10 GB of the physical storage, when the 10 GB physical storage is filled and an additional physical storage is installed, there arises a troublesome problem involved in the addition of the physical storage that the recognition of the data file server concerning the capacity of the physical storage has to be changed and the file configuration has to be changed accordingly, for example. However, if the data file server originally recognizes a high storage capacity (500 GB, herein), there is provided an advantage that, when the storage capacity of the physical storage (10 GB herein) is insufficient, the shortage of storage capacity can be addressed by simply providing an additional physical storage without any change or modification to the data file server.

Such a virtual storage system can avoid the excess of storage area initially provided because the physical storage is assigned as required. However, it has a disadvantage that, once the physical storage is assigned, the physical storage is not released in the virtual storage system even if a file or data is deleted from the data file server.

The virtual storage system providing the virtual disk is equivalent to a controller of the disk device, and at the level of the controller (virtual storage system), the type of the file system of the disk or which region is available on the disk is not known. How to use the disk is at the discretion of the data file server, and the disk controller can only process the access requests made by the data file server.

Deletion of a file from the file system operating on the data file server results in only a modification of the management information of the data file server for managing the file. That is, even when a function such as complete data deletion is used, actually, a request to write a data representing that the data is deleted is made. Thus, disk controller (the virtual storage system operating on the data access server) cannot discriminate between writing of effective data and writing of data deletion.

Thus, in the case where the amount of data steadily increases in operation, the virtual disk according to the method described above is effective. However, in the case where the amount of data increases and decreases, the virtual disk according to this method is less advantageous because a large volume of physical storage may be used (assigned) in the virtual storage system of the data access server although only a small amount of virtual disk is used in the file system operating on the data file server.

As a method of releasing the unused region of the physical storage, there may be contemplated a method of coping the used region of the physical storage to another virtual disk, releasing the whole region of the original physical storage and using the copy physical storage. In this case, however, there are problems that the capacity for the copy has to be additionally prepared, and access to the original physical storage has to be inhibited (operation has to be stopped) during data copy.

FIG. 2 is a diagram for illustrating deletion of a file or data from a data file server.

It is assumed that an address translation table shown in this drawing is provided in the virtual storage system of the data access server.

Specifically, it is assumed that physical blocks 1, 5, 8, 6, 7, 4 and 15 are assigned to logical blocks 1, 2, 3, 4, 5, 8 and 9, respectively. Furthermore, it is assumed that a file B composed of the logical blocks 4 and 5 is deleted from the data file server. The deletion of the file B results in only a modification of the file management information managed by the file system operating on the data file server, and the virtual storage system of the data access server has no concern with the file management information. Therefore, the address translation table is not modified at all, and thus, the logical blocks 4 and 5 remain associated with the physical blocks 6 and 7, respectively. Therefore, even if the logical blocks 4 and 5 are not used in the data file server, the physical blocks 6 and 7 associated with the logical blocks 4 and 5 will not be associated with other logical blocks, so that the physical blocks 6 and 7 will remain unused wastefully.

According to a technique proposed in the patent reference 1, to physically delete the unnecessary logically deleted data, a database management system incorporates means that determines whether unnecessary logically deleted data can be physically deleted or not, extracts the data from the data record of data to be physically deleted and physically deletes the data, thereby omitting reorganization of a database and reducing dependency on an application program. However, the technique disclosed in the patent reference 1 is not suitable for such a data file system having a data file server and a data access server described above.

Besides the technique disclosed in the patent reference 1, there have been various techniques for deleting or releasing an unused region of the physical storage (patent references 2, 3, 4, 5, 6, 7 and 8 as listed below). However, they cannot solve the above-described problems with the data file system having a data file server and a data access server.

Patent reference 1: Japanese Patent No. 2624170

Patent reference 2: Japanese Patent Laid-Open No. 2003-85027

Patent reference 3: Japanese Patent Laid-Open No. 2-141841

Patent reference 4: Japanese Patent Laid-Open No. 7-153284

Patent reference 5: Japanese Patent Laid-Open No. 2000-47891

Patent reference 6: Japanese Patent Laid-Open No. 2003-58417

Patent reference 7: Japanese Patent Laid-Open No. 2001-101050

Patent reference 8: Japanese Patent Laid-Open No. 63-61346

### SUMMARY OF THE INVENTION

In view of such circumstances, an object of the present invention is to provide a data file system having a data access server that has a physical storage for storing data and accesses the physical storage in response to an access request and a data file server that performs data filing by transmitting an access request to the data access server and using the data access server for data saving, the data file system further having an arrangement that efficiently release a physical block when a logical block becomes unused. In addition, another object of the present invention is to provide a data access server suitable for constituting such a data file system and a data access program storage medium that stores a data access program that makes an information processing device operate as such a data access server.

Of data file systems according to the present invention that attain the objects described above, a first data file system is a data file system having:
a data access server that has a physical storage for storing data and accesses the physical storage in response to an access request; and
a data file server that performs data filing by transmitting an access request to the data access server and using the data access server for data saving,
in which the data access server has:
a request reception section that receives the access request from the data file server;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server, and
the association table management section searches through logical blocks assigned respective physical blocks for a logical block for which no access request is made within a predetermined period, releases the physical block assigned to the logical block from the association with the logical block and includes the physical block in unused physical block.

Since the association table management section searches through logical blocks assigned respective physical blocks for a logical block for which no access request is made within a predetermined period, releases the physical block assigned to the logical block from the association with the logical block and includes the physical block in unused physical block, the first data file system can release a physical block associated with an unused logical block from the association and include the physical block in unused physical blocks.

In the first data file system, the data file server preferably has an all-used-block-access request section that makes access requests to all the logical blocks used by the data file server within the predetermined period to the data access server.

Since the access request to all the logical blocks used by the data file serve are made, any unused logical block can be recognized with reliability, and the physical block associated with the unused logical block can be released from the association.

In addition, of the data file systems according to the present invention that attain the objects described above, a second data file system is a data file system having:
a data access server that has a physical storage for storing data and accesses the physical storage in response to an access request; and
a data file server that performs data filing by transmitting an access request to the data access server and using the data access server for data saving,
in which the data access server has:
a request reception section that receives the access request from the data file server;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical block; and
a result transmission section that transmits the result of access by the access section to the data file server,
the data file server has a discrimination information transmission section that transmits, to the data access server, discrimination information that discriminates between logical blocks being used by the data file server and unused logical blocks of all the logical blocks, and
the association table management section searches through logical blocks assigned respective physical blocks for an unused logical block based on the discrimination information transmitted from the data file server, releases the physical block assigned to the unused logical block from the association with the logical block and includes the physical block in unused physical block.

Since the data file server has a discrimination information transmission section that transmits, to the data access server, discrimination information that discriminates between logical blocks being used by the data file server and unused logical blocks of all the logical blocks, and the association table management section in the data access server searches through logical blocks assigned respective physical blocks for an unused logical block based on the discrimination information transmitted from the data file server, releases the physical block assigned to the unused logical block from the association with the logical block and includes the physical block in unused physical block, the second data file system according to the present invention can recognize any unused logical block with reliability and release the physical block associated with the unused logical block from the association.

Of data access servers according to the present invention, a first data access server is a data access server that has a physical storage for storing data and accesses the physical storage in response to an access request, the data access server further having:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
in which the association table management section searches through logical blocks assigned respective physical blocks for a logical block for which no access request is made within a predetermined period, releases the physical block assigned to the logical block from the association with the logical block and includes the physical block in unused physical block.

Of the data access servers according to the present invention, a second data access server is a data access server that has a physical storage for storing data and accesses the physical storage in response to an access request, the data access server further having:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical block; and
a result transmission section that transmits the result of access by the access section to the data file server,
in which the association table management section searches through logical blocks assigned respective physical blocks for an unused logical block based on discrimination information that is transmitted from the data file server and discriminates between logical blocks being used by the data file server and unused logical blocks of all the logical blocks, releases the physical block assigned to the unused logical block from the association with the logical block and includes the physical block in unused physical block.

Of data access program storage media according to the present invention that attain the objects described above, a first data access program storage medium is a data access program storage medium that stores a data access program that runs in an information processing device to make the information processing device operate as a data access server which accesses a physical storage in response to an access request, the information processing device having the physical storage for storing data and allowing a program to run therein,
in which the data access program storage medium stores a data access program that makes the information processing device operate as a data access server having:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical block; and
a result transmission section that transmits the result of access by the access section to the data file server, and
the association table management section searches through logical blocks assigned respective physical blocks for a logical block for which no access request is made within a predetermined period, releases the physical block assigned to the logical block from the association with the logical block and includes the physical block in unused physical block.

Furthermore, of the data access program storage media according to the present invention that attain the objects described above, a second data access program storage medium is a data access program storage medium that stores a data access program that runs in an information processing device to make the information processing device operate as a data access server which accesses a physical storage in response to an access request, the information processing device having the physical storage for storing data and allowing a program to run therein,
in which the data access program storage medium stores a data access program that makes the information processing device operate as a data access server having:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server, and
the association table management section searches through logical blocks assigned respective physical blocks for an unused logical block based on discrimination information that is transmitted from the data file server and discriminates between logical blocks being used by the data file server and unused logical blocks of all the logical blocks, releases the physical block assigned to the unused logical block from the association with the logical block and includes the physical block in unused physical block.

As described above, according to the present invention, in a data file system having a data access server that has a physical storage for storing data and accesses the physical storage in response to an access request and a data file server that performs data filing by transmitting an access request to the data access server and using the data access server for data saving, a physical block associated with a logical block that is not used in the data file server can be released from the association in the data access server and the released physical block can be included in unused physical blocks.

### BRIEF DESCRIPTION OF THE DRAWINGS

FIG. 1 is a diagram illustrating a method of implementing a virtual storage system;

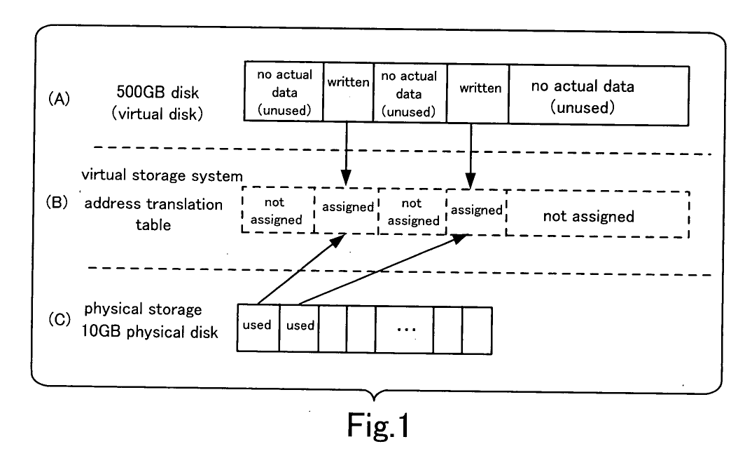

FIG. 2 is a diagram for illustrating deletion of a file or data from a data file server;

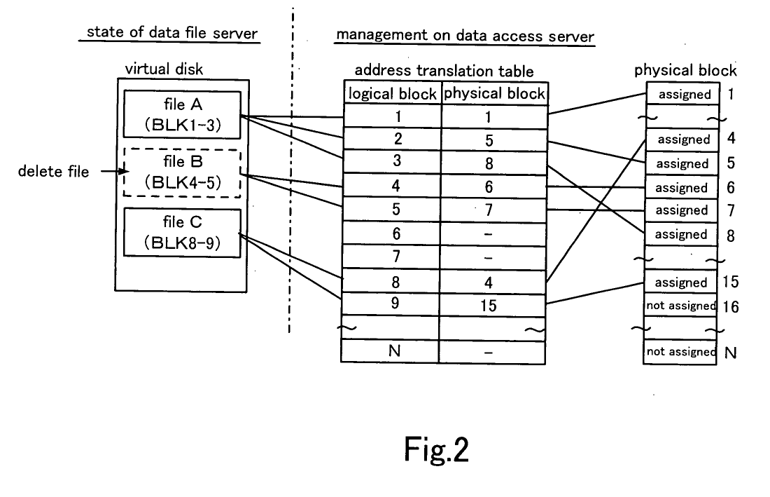

FIG. 3 is a schematic diagram showing a data file system according to a first embodiment of the present invention;

FIG. 4 shows a hardware configuration of computers having appearances shown in FIG. 3;

FIG. 5 is a conceptual diagram of a data file program;

FIG. 6 is a conceptual diagram of a data access program;

FIG. 7 is a functional diagram of the data file system according to this embodiment;

FIG. 8 is a diagram for illustrating an operation of releasing a physical block in the data file system shown in FIG. 7;

FIG. 9 is a conceptual diagram of a data file program according to a second embodiment;

FIG. 10 is a functional diagram of a data file system according to the second embodiment;

FIG. 11 is a diagram illustrating a synchronous-type system; and

FIG. 12 is a diagram illustrating an asynchronous-type system.

### DETAILED DESCRIPTION OF THE PREFERRED EMBODIMENTS

Now, embodiments of the present invention will be described.

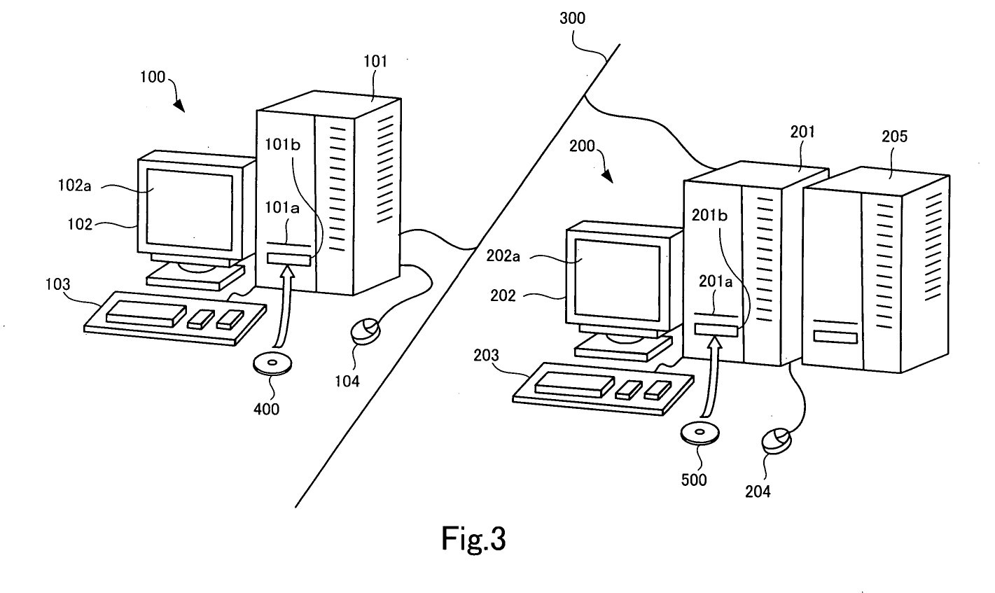

FIG. 3 is a schematic diagram showing a data file system according to a first embodiment of the present invention.

The data file system as a minimum unit will be described.

FIG. 3 shows two computers 100 and 200, which are connected to each other via a communication line 300. In general, the computers 100 and 200 may be a computer, such as that referred to as a workstation or personal computer. The communication line 300 is composed of an access path (I/O path) that provides a virtual disk to a data file server (computer 100) and a local area network (LAN).

One of the two computers 100 and 200, specifically, the computer 100 serves as the data file server of the data file system, and the other computer 200 serves as a data access server of the data file system. In the computer 100 serving as the data file server, a data file program for implementing data filing is installed and executed. The data file server performs data filing by transmitting an access request to the computer 200 serving as the data access server via the communication line 300 and using the computer 200 for saving data. On the other hand, the computer 200 serving as the data access server has a bulk hard disk, which is equivalent to the physical storage in the present invention. In the computer 200, a data access program is installed and executed, and the hard disk is accessed in response to an access request from the data file server (computer 100).

In the following, hardware configurations of the computers will be described first.

The computer 100 (200) has: a main section 101 (201) incorporating a central processing unit (CPU), a random access memory (RAM), a hard disk, a communication board or the like; a display section 102 (202) that displays an image or character sequence on a display screen 102a (202a) in response to an instruction from the main section 101 (201); a keyboard 103 (203) used by a user to enter an instruction to the computer 100 (200); and a mouse 104 (204) that designates an arbitrary point on the display screen 102a (202a) and allows entry of an instruction corresponding to an icon or the like displayed at that point at that time.

In addition, the main section 101 (201) has, on the outside, a flexible disk insertion slot 101a (201a) through which a flexible disk (not shown) is loaded and a CD-ROM insertion slot 101b (201b) through which a CD-ROM 400 (500) is loaded. Furthermore, the main section 101 (201) incorporates an FD drive and a CD-ROM drive that drive and access the flexible disk (abbreviated as FD, hereinafter) and the CD-ROM 400 (500) loaded through the insertion slots 101a (201a) and 101b (201b), respectively.

Besides the hard disk incorporated in the main section 201, the computer 200, which serves as the data access server, has a hard disk device 205 incorporating a bulk hard disk. The bulk hard disk in the hard disk device 205 is accessed in response to an access request from the computer 100 serving as the data file server and is equivalent to the physical storage according to the present invention.

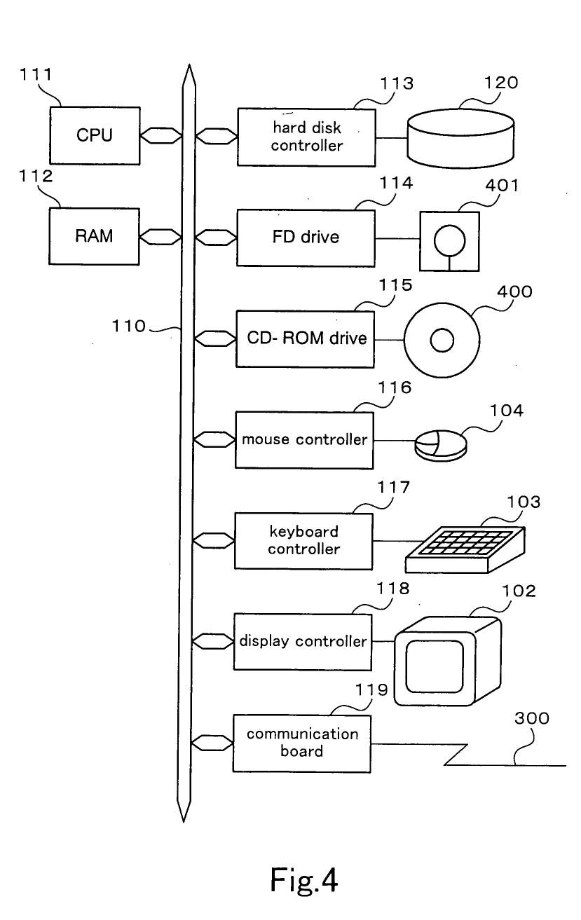

FIG. 4 shows a hardware configuration of the computers having the appearances shown in FIG. 3. In the following, the computer 100 will be described as a representative example. However, the computer 200 has the same configuration except that it has additionally the hard disk device incorporating the bulk hard disk.

In the hardware configuration view of FIG. 4, there is shown a CPU 111, an RAM 112, a hard disk controller 113, an FD drive 114, a CD-ROM drive 115, a mouse controller 116, a keyboard controller 117, a display controller 118 and a communication board 119, which are connected to each other via a bus 110.

As described with reference to FIG. 3, the FD drive 114 and the CD-ROM drive 115 are to access a flexible disk 401 and the CD-ROM 400 loaded through the FD insertion slot 101a and the CD-ROM insertion slot 101b, respectively. The communication board 119 is connected to the communication line 300 composed of the I/O path and the LAN.

In addition, FIG. 3 shows a hard disk 120 accessed by the hard disk controller 113, the mouse 104 controlled by the mouse controller 116, the keyboard 103 controlled by the keyboard controller 117, and the CRT display 102 controlled by the display controller 118.

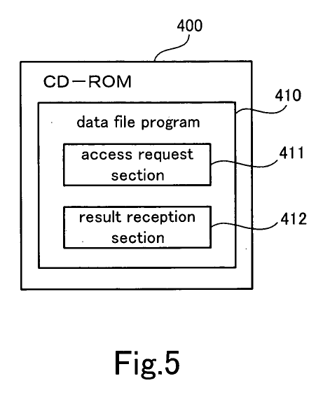

FIG. 5 is a conceptual diagram of a data file program.

A data file program 410 shown in FIG. 5 has an access request section 411 and a result reception section 412 and is stored in the CD-ROM 400 shown in FIG. 3.

The CD-ROM 400 storing the data file program 410 is loaded into one (computer 100) of the two computers 100, 200 shown in FIG. 3 through the CD-ROM insertion slot 101b and accessed by the CD-ROM drive 115 shown in FIG. 4, whereby the data file program 410 stored in the CD-ROM 400 is uploaded to the computer 100 and stored in the hard disk 120. The data file program stored in the hard disk 120 is read, developed in the RAM 112 and executed by the CPU 111, thereby allowing the computer 100 to operate as the data file server.

Operations of the sections 411 and 412 of the data file program 410 shown in FIG. 5 will be described later.

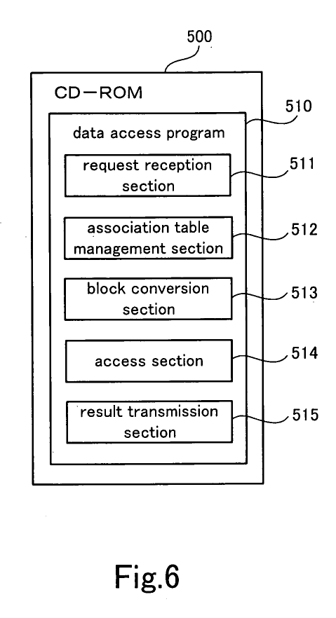

FIG. 6 is a conceptual diagram of a data access program.

A data access program 510 shown in FIG. 6 has a request reception section 511, an association table management section 512, a block conversion section 513, an access section 514 and a result transmission section 515. The data access program 510 shown in FIG. 6 is stored in the CD-ROM 500, and The CD-ROM 500 is loaded into one (computer 200) of the two computers 100, 200 shown in FIG. 3 through the CD-ROM insertion slot 201b and accessed by the CD-ROM drive (see the CD-ROM drive 115 in FIG. 4) of the computer 200, whereby the data access program 510 stored in the CD-ROM 500 is uploaded to the computer 200 and stored in the hard disk (see the hard disk 120 in FIG. 4) of the computer 200. Then, the data access program stored in the hard disk is read, developed in the RAM (see RAM 112 in FIG. 4) and executed by the CPU (see the CPU 111 in FIG. 4), thereby allowing the computer 200 to operate as the data access server.

Operations of the sections 511 to 515 of the data access program 510 shown in FIG. 6 will be described later.

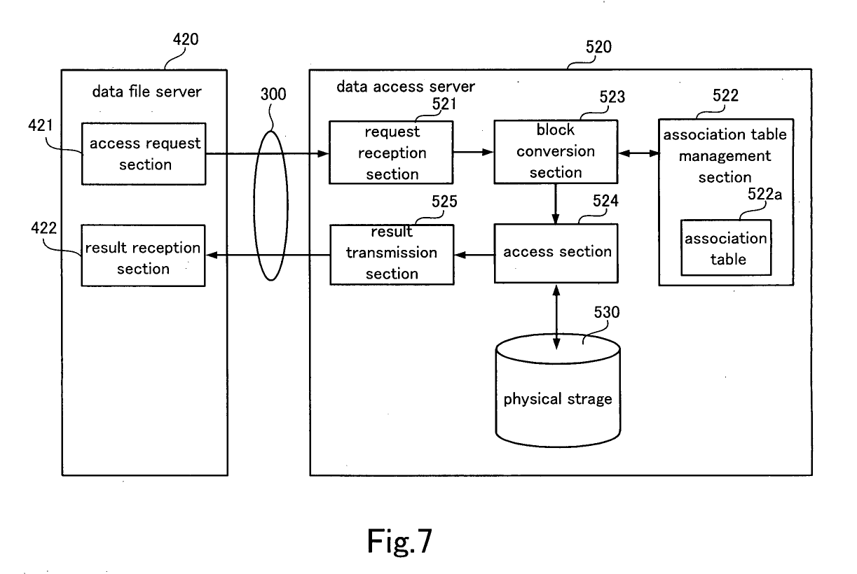

FIG. 7 is a functional diagram of the data file system according to this embodiment.

The data file system shown in FIG. 7 has a data file server 420 and a data access server 520, which are connected to each other via the communication line 300.

The data file server 420 has an access request section 421 and a result reception section 422. The data file server 420 may have a section that performs calculation or the like besides the access request section 421 and the result reception section 422, although only the sections involved in communication with the data access server 520 are shown in this drawing.

The data access server 420 is implemented by the data file program 410 shown in FIG. 5 installed and executed in one (computer 100) of the two computers 100, 200 shown in FIG. 3. The access request section 421 and the result reception section 422 are implemented by the access request section 411 and the result reception section 412 of the data file program 410 shown in FIG. 5, respectively.

That is, the access request section 421 and the result reception section 422 of the data file server 420 shown in FIG. 7 are composed of the access request section 411 and the result reception section 412 of the data file program 410 shown in FIG. 5, the hardware of the computer 100 shown in FIGS. 3 and 4, and an operating system (OS) or the like. Operations of the access request section 411 and the result reception section 412 of the data file program 410 shown in FIG. 5 executed in the computer 100 are exactly the same as the operations of the access request section 421 and the result reception section 422 of the data file server 420 shown in FIG. 7. Thus, in this specification, only the operations of the access request section 421 and the result reception section 422 of the data file server 420 shown in FIG. 7 will be described, which description will be applied also to the operations of the access request section 411 and the result reception section 412 of the data file program 410 shown in FIG. 5.

The data access server 520 of the data file system shown in FIG. 7 has a request reception section 521, an association table management section 522, a block conversion section 523, an access section 524, a result transmission section 525 and a physical storage 530. The physical storage 530 serves the function of the hard disk device 205 incorporating the bulk hard disk shown in FIG. 3.

The data access server 520 shown in FIG. 7 is implemented by the data access program 510 shown in FIG. 6 installed and executed in one (computer 200) of the two computers 100, 200 shown in FIG. 3. The sections 521 to 525 of the data access server 520 shown in FIG. 7 except for the physical storage 530 are functional sections implemented by their respective corresponding sections 511 to 515 of the data access program 510 shown in FIG. 6.

That is, the sections 521 to 525 of the data access server 520 shown in FIG. 7 except for the physical storage 530 are composed of the sections 511 to 515 of the data access program 510 shown in FIG. 6, the hardware of the computer 200 shown in FIG. 3, and an operating system (OS) running on the computer 200 or the like. Operations of the sections 511 to 515 of the data access program 510 shown in FIG. 6 executed in the computer 200 are exactly the same as the operations of their respective corresponding sections 521 to 525 of the data access server 520 shown in FIG. 7. Thus, in this specification, only the operations of the sections of the data access server 520 shown in FIG. 7 will be described, which description will be applied also to the operations of the cores of the data access program 510 shown in FIG. 6.

In the following, operations of the sections of the data file system shown in FIG. 7 will be described.

The data file server 420 of the data file system shown in FIG. 7 performs data filing by transmitting an access request to the data access server 520 and using the data access server 520 for data saving. The access request section 421 of the data file server 420 serves to transmit an access request to write data to or read data from the data access server 520 to the data access server 520. The access request section 421 serves also to transmit access requests to read all the logical blocks (described later) used in the data file server 420 to the data access server 520 at regular intervals, for example, once a day. That is, the access request section 421 is also equivalent to an all-used-block-access request section according to the present invention.

The result reception section 422 of the data file server 420 shown in FIG. 7 serves to receive a report on the access result when the access request section 421 transmits an access request to the data access server 520 and the data access server 520 accesses the physical storage 530 in response to the access request. The “access result” may be a report that data writing is adequately attained or fails due to an error when a data write request is made, or read data itself when a data read request is made, for example.

On the other hand, the request reception section 521 of the data access server 520 serves to receive an access request from the data file server 420, and the access request received by the request reception section 521 is transferred to the block conversion section 523.

However, the association table management section 522 will be described before describing the block conversion section 523.

The association table management section 522 has an association table 522a. The association table 522a represents an association between plural physical blocks, which are storage blocks resulting from dividing the physical storage 530, and logical blocks recognized as storage blocks by the data file server 420. The association table 522a is an address translation table referred to when translating a logical block into a physical block. When an access request from the data file server 420 is received, if no physical block is assigned to the logical block to be accessed, the association table management section 522 assigns one of the unused physical blocks to the logical block to be accessed.

As described later, if no access request is made for a logical block assigned a physical block for a predetermined period, the association table management section 522 serves to release the physical block from the association with the logical block and include the released physical block in unused physical blocks.

Upon receiving an access request from the data file server 420, the block conversion section 523 refers to the association table (address translation table) 522a to translate the address of the logical block to be accessed into the address of a physical block and notifies the access section 524 of the physical block to be accessed.

Upon receiving the notification of the physical block to be accessed from the block conversion section 523, the access section 524 accesses the physical block to be accessed in the physical storage 530.

The result of the access by the access section 524 to the physical storage 530 is passed to the result transmission section 525. The result transmission section 525 transmits the access result (for example, a report on the success or failure of data writing if the current access request is a data write request, or read data itself if the current access request is a data read request) to the data file server 420.

The access result transmitted by the result transmission section 525 is received by the result reception section 422 of the data file server 420.

If there is a physical block which is once used by the data file server 420 and then become unused, the association table 522a is reorganized in the following manner.

The data file server 420 makes access requests for the whole logical blocks used by the data file server 420 to the data access server 520 within a predetermined time once a day, for example. Within the predetermined time, the association table management section 522 checks which logical addresses the access requests are received for, and if no access request is made for a logical block assigned a physical block for the predetermined time, the association table management section 522 releases the physical block from the association with the logical block and includes the released physical block in unused physical blocks. Thus, the physical block having been associated with the logical block that is once used and then become unused is released from the association. As a result, a physical block can be prevented from being continuously tied to an unused logical block, and when an access request to a new logical block with which any physical block has not been associated is made, the released physical block can be associated with the new logical block.

In the data file server 420, conventional data backup software is activated once a day, for example, and data backup is performed by making access requests concerning all the files (logical blocks) effectively used in the data file server to the data access server.

The data backup software may be activated to actually perform data backup, but it may be activated only to simply release a physical block associated with an unused logical block from the association. In the latter case, the data read from the physical storage 530 and transmitted to the data file server may not be stored in another place for backup, and may be processed to be stored in a virtual disk and be lost without being actually stored for backup. However, as for the I/O requests to the virtual disk, normal termination has to be notified.

In this case, since the purpose of the operation is not backup, an access request can be made to the data access server from other components than the backup software (that is, the system can be operated) even during backup (not actual backup but virtual backup in which the backup software operates).

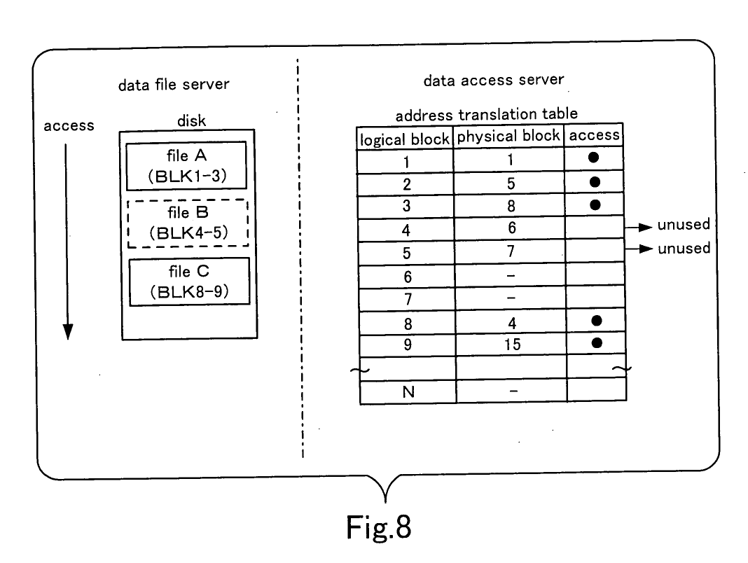

FIG. 8 is a diagram for illustrating an operation of releasing a physical block in the data file system shown in FIG. 7.

In the data file server, the data backup software is executed, and access requests are made to read all the physical blocks of all the files used in the data file server.

Upon receiving the access requests, the data access server (specifically, the association table management section 522 shown in FIG. 7) checks which logical blocks in the address translation table are accessed. Here, the address translation table describes an association between the logical blocks and the physical blocks. Then, if the logical blocks associated with the physical blocks (logical blocks 1, 2, 3, 4, 5, 8 and 9 in the example shown in FIG. 8) include a logical block that is not accessed at all (blocks 4, 5 in the example shown in FIG. 8), the association table management section 522 releases the physical block associated with the logical block (physical blocks 6, 7 in the example shown in FIG. 8) from the association with the logical block and includes the released physical block in unused physical blocks. In this way, the physical block released from the association with the logical block can be associated with a new logical block, and thus, the resources of the physical storage can be efficiently used. Instead of immediately deleting the physical block associated with the logical block that is not accessed within the predetermined time, an inquiry concerning whether to delete the physical block or not may be made to the data file server to refer to a user for decision, and the physical block may be deleted after receiving the instruction to delete the physical block.

Now, a data file system according to a second embodiment of the present invention will be described.

The data file system according to the second embodiment described herein differs from the system according to the first embodiment only in a part of the software and has the same computer hardware configuration shown in FIGS. 3 and 4. Thus, as for the concept of the computer hardware, FIGS. 3 and 4 and descriptions thereof will be used in the following description of the second embodiment.

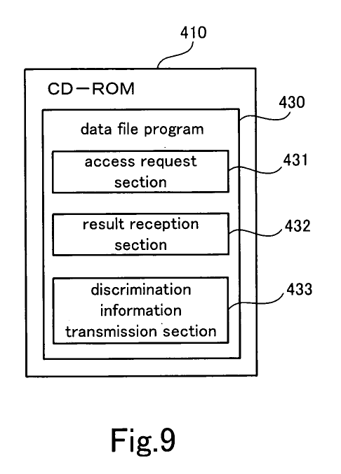

FIG. 9 is a conceptual diagram of a data file program according to the second embodiment.

A data file program 430 shown in FIG. 9 has a discrimination information transmission section 433 in addition to an access request section 431 and a result reception section 432, which are equivalent to the access request section 411 and the result reception section 412, respectively, of the data file program 410 according to the first embodiment shown in FIG. 5.

Operations of the sections 431 to 433 of the data file program 430 shown in FIG. 9 will be described later.

The process of uploading the data file program 430 shown in FIG. 9 to the computer 100 shown in FIG. 3 and executing the program in the computer is the same as the process for the data file program 410 according to the first embodiment shown in FIG. 5. Therefore, description thereof will be omitted.

Furthermore, a data access program according to the second embodiment is the same as the data access program 510 according to the first embodiment shown in FIG. 6 in terms of conceptual representation. Therefore, as for the names, reference numerals and the like of the sections of the data access program, FIG. 6 will be referred to. Differences in operation from the data access program according to the first embodiment will be described later.

The process of uploading the data access program 510 shown in FIG. 6 to the computer 200 shown in FIG. 3 and executing the program in the computer according to the second embodiment is the same as the process according to the first embodiment. Therefore, description thereof will be omitted.

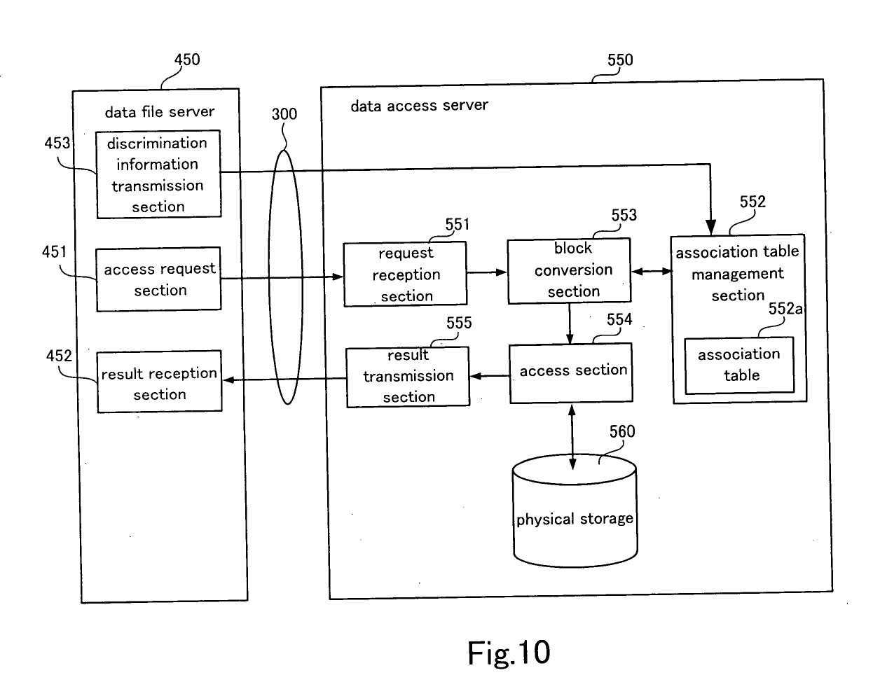

FIG. 10 is a functional diagram of the data file system according to the second embodiment.

The data file system shown in FIG. 10 has a data file server 450 and a data access server 550, which are connected to each other via a communication line 300 composed of an I/O path and an LAN.

The data file server 450 has an access request section 451, a result reception section 452 and an discrimination information transmission section 453. As in the first embodiment described above, the data file server 450 may have a section that performs calculation or the like besides the access request section 451, the result reception section 452 and the discrimination information transmission section 453, although only the sections involved in communication with the data access server 550 are shown in this drawing.

The data access server 450 is implemented by the data file program 430 shown in FIG. 9 installed and executed in one (computer 100) of the two computers 100, 200 shown in FIG. 3. The access request section 451, the result reception section 452 and the discrimination information transmission section 453 are implemented by the access request section 431, the result reception section 432 and the discrimination information transmission section 433 of the data file program 430 shown in FIG. 9, respectively.

That is, the access request section 451, the result reception section 452 and the discrimination information transmission section 453 of the data file server 450 shown in FIG. 10 are composed of the access request section 431, the result reception section 432 and the discrimination information transmission section 433 of the data file program 430 shown in FIG. 9, the hardware of the computer 100 shown in FIGS. 3 and 4, and an operating system (OS) or the like. Operations of the access request section 431, the result reception section 432 and the discrimination information transmission section 433 of the data file program 430 shown in FIG. 9 executed in the computer 100 are exactly the same as the operations of the access request section 451, the result reception section 452 and the discrimination information transmission section 453 of the data file server 450 shown in FIG. 10. Thus, in this specification, only the operations of the access request section 451, the result reception section 452 and the discrimination information transmission section 453 of the data file server 450 shown in FIG. 10 will be described, which description will be applied also to the operations of the access request section 431, the result reception section 432 and the discrimination information transmission section 433 of the data file program 430 shown in FIG. 9. As for the sections 451 to 453 of the data file server 450 shown in FIG. 10, only the differences from the operations of the sections 421 to 422 of the data file server 420 according to the first embodiment shown in FIG. 7 will be described.

The data access server 550 of the data file system shown in FIG. 10 has a request reception section 551, an association table management section 552, a block conversion section 553, an access section 554, a result transmission section 555 and a physical storage 560. Just like the physical storage 530 according to the first embodiment shown in FIG. 7, the physical storage 560 serves the function of the hard disk device 205 incorporating the bulk hard disk shown in FIG. 3.

The data access server 550 shown in FIG. 10 is implemented by the data access program 510 shown in FIG. 6 (this data access program 510 is assumed as the data access program according to the second embodiment) installed and executed in one (computer 200) of the two computers 100, 200 shown in FIG. 3. The sections 551 to 555 of the data access server 550 shown in FIG. 10 except for the physical storage 560 are functional sections implemented by their respective corresponding sections 511 to 515 of the data access program 510 shown in FIG. 6.

That is, the sections 551 to 555 of the data access server 550 shown in FIG. 10 except for the physical storage 560 are composed of the sections 511 to 515 of the data access program 510 shown in FIG. 6, the hardware of the computer 200 shown in FIG. 3, and an operating system (OS) running on the computer 200 or the like. Operations of the sections 511 to 515 of the data access program 510 shown in FIG. 6 executed in the computer 200 are exactly the same as the operations of their respective corresponding sections 551 to 555 of the data access server 550 shown in FIG. 10. Thus, in this specification, only the operations of the sections of the data access server 550 shown in FIG. 10 will be described, which description will be applied also to the operations of the sections of the data access program 510 adapted for the second embodiment shown in FIG. 6.

Also as for the data access server 550 shown in FIG. 10, description of operations thereof common to the data access server 520 according to the first embodiment shown in FIG. 7 will be omitted, and only the differences from the operations of the data access server 520 according to the first embodiment will be described.

The access request section 451 of the data file server 450 serves to transmit, to the data access server 550, an access request to write data to the data access server 550 or read data from the data access server 550.

The access request section 421 of the data file server 420 according to the first embodiment shown in FIG. 7 serves also to transmit access requests to read all the logical blocks used in the data file server 420 to the data access server 520 according to the first embodiment at regular intervals, for example, once a day. However, the access request section 451 of the data file server 450 according to the second embodiment shown in FIG. 10 is not required to read all the logical blocks at regular intervals.

The result reception section 452 of the data file server 450 shown in FIG. 10 is the same as the result reception section 422 of the data file server 420 according to the first embodiment shown in FIG. 7. Thus, description thereof will be omitted.

The discrimination information transmission section 453 of the data file server 450 shown in FIG. 10 serves to transmit, to the data access server 550, discrimination information that discriminates between logical blocks being used by the data file server 450 and unused logical blocks of all the logical blocks.

The sections 551 to 555 of the data access server 550 of the data file system shown in FIG. 10 excluding the association table management section 552, that is, the sections 551 and 553 to 555 operate the same as their respective corresponding sections 521 and 523 to 525 of the data access server 520 of the data file system according to the first embodiment shown in FIG. 7, and thus, description thereof will be omitted. Furthermore, the physical storage 560 provided in the data access server 550 shown in FIG. 10 is also the same as the physical storage 530 provided in the data access server 520 shown in FIG. 7 as described above.

As for the association table management section 552, the association table (address translation table) 552a provided in the association table management section 552 is the same as the association table provided in the association table management section 522 of the data access server 520 shown in FIG. 7.

Based on the discrimination information that discriminates between the logical blocks being used by the data file server 450 and the unused logical blocks which is transmitted from the data file server 450, the association table management section 552 of the data access server 550 shown in FIG. 10 searches through the logical blocks assigned their respective physical blocks for an unused logical block, releases the physical block assigned to the unused logical block from the association with the logical block and includes the released physical block in unused physical blocks.

Thus, as in the first embodiment described above, the physical block associated with the logical block that is once used by the data file server 450 and then become unused is released from the association. Thus, when an access request to a new logical block that is not associated with a physical block is made, the released physical block can be associated with the new logical block, so that the physical blocks can be efficiently used.

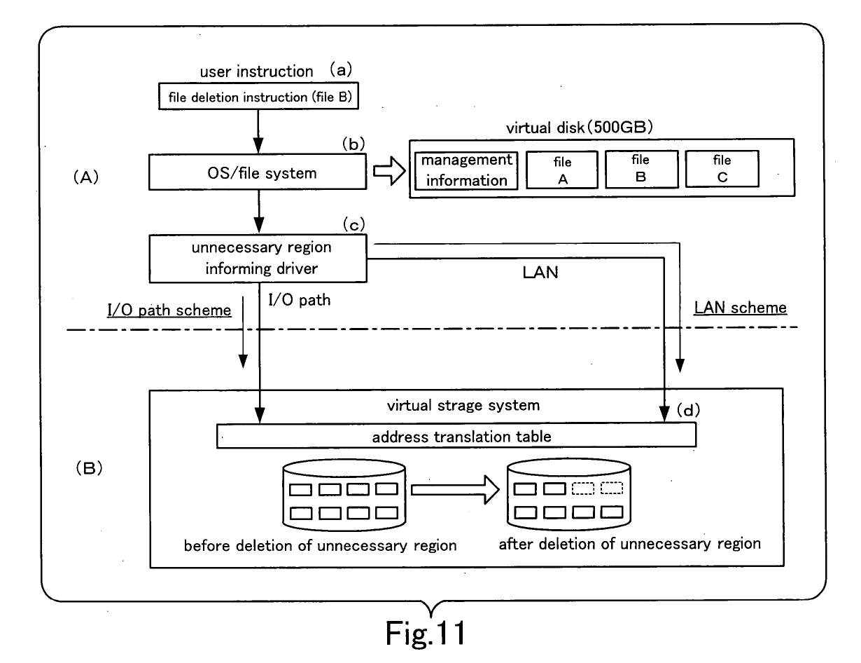

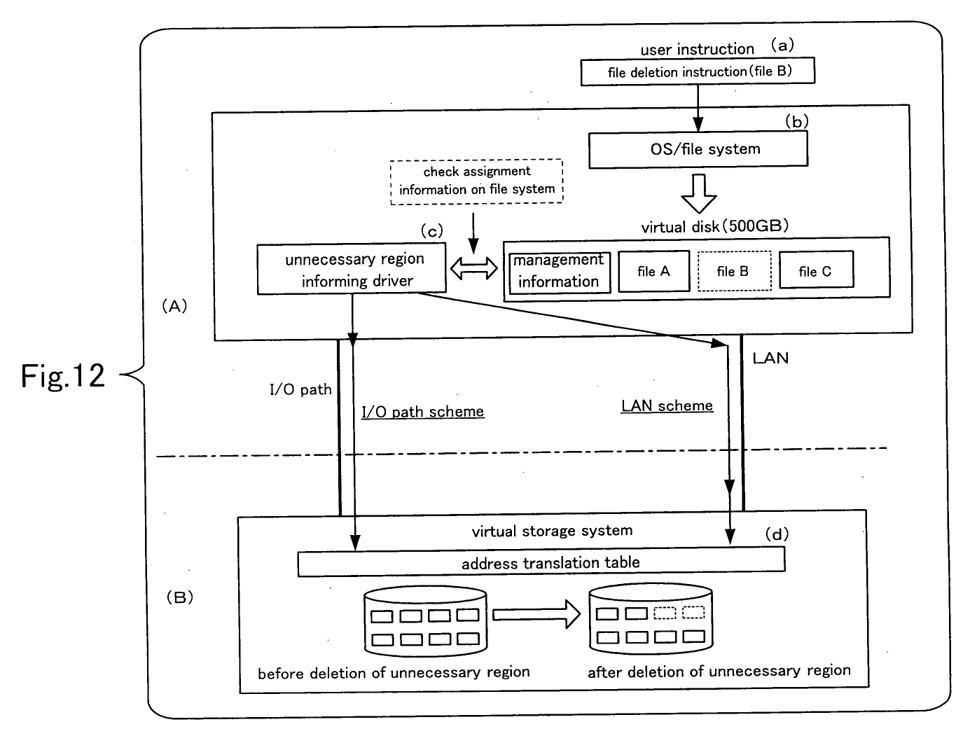

FIGS. 11 and 12 are diagrams for illustrating operations of releasing a physical block in the data file system shown in FIG. 10.

In both FIGS. 11 and 12, part (A) denotes an operation on the side of the data file server, and part (B) denotes an operation on the side of the data access server.

In the data file server, a program (driver) that cooperates with the file system operating on the data file server is prepared, thereby providing a mechanism that informs the virtual storage system in the data access server of a region (logical block) that has become unnecessary for the file system, thereby deleting (releasing) the unnecessary physical block.

Methods for realizing cooperation with the file system and informing the virtual storage system of the unnecessary region (unnecessary logical block) are categorized into a synchronous type and an asynchronous type. According to a synchronous-type method, which involves synchronous cooperation with the file system, the driver informs the virtual storage system of the unnecessary region when a file is deleted and thus the management information of the file system is changed. According to an asynchronous-type method, the management information of the file system is checked and the virtual storage system is informed of the unnecessary region (or the actually used region) at regular intervals.

Besides, methods for informing the virtual storage system of the unnecessary region or actually used region are categorized into an LAN scheme and an I/O path scheme. In the LAN scheme, the virtual storage system operating on the data access server and the data file server using the virtual disk are connected to each other via an LAN, and the virtual storage system is informed of the unnecessary region via the LAN. In the I/O path scheme, an access path (I/O path) that provides the virtual disk to the data file server is used to issue a special I/O command to the virtual disk, thereby allowing the virtual storage system to recognize the unnecessary region.

FIG. 11 is a diagram illustrating a synchronous-type system. On the data file server side, a user enters a file deletion instruction (to delete a file B, here) (step a). Then, the OS/file system rewrites the management information about a 500 GB virtual disk, for example, in the data file server, and thus, the file B is deleted from the data file server (step b).

Once the OS/file system rewrites the management information about the virtual disk, the unnecessary-region informing driver provides the rewritten management information (discrimination information) to the virtual storage system in the data access server (step c). This informing process is carried out in the I/O path scheme or LAN scheme. In the case of the I/O path scheme, an access path (I/O path) that provides the virtual disk to the data file server is used, and in the case of the LAN scheme, a local area network (LAN) is used.

Based on the provided management information, the virtual storage system in the data access server checks for a logical block that is not used by the data file server through the logical blocks associated with their respective physical blocks, and, if there is a logical block that is associated with a physical block but is not used, modifies the association described in the address translation table, thereby releasing the physical block associated with the unused logical block from the association (step d). In this way, the unnecessary region of the physical storage is deleted.

FIG. 12 is a diagram illustrating an asynchronous-type system.

As in the case shown in FIG. 11, on the data file server side, a user enters a file deletion instruction (to delete a file B, here) (step a). Then, the OS/file system rewrites the management information about a 500 GB virtual disk, for example, in the data file server, and thus, the file B is deleted from the data file server (step b). The unnecessary-region informing driver retrieves the management information about the virtual disk and provides the same to the virtual storage system in the data access server at regular intervals regardless of the timing of the rewriting of the management information about the virtual disk by the OS/file system (step c). As in the case shown in FIG. 11, this informing process is carried out in the I/O path scheme or LAN scheme.

Based on the provided management information, the virtual storage system in the data access server checks for a logical block that is not used by the data file server through the logical blocks associated with their respective physical blocks, and, if there is a logical block that is associated with a physical block but is not used, modifies the association described in the address translation table, thereby releasing the physical block associated with the unused logical block from the association (step d). In this way, the unnecessary region of the physical storage is deleted.

1. A data file system comprising:
a data access server that has a physical storage for storing data and accesses the physical storage in response to an access request; and
a data file server that performs data filing by transmitting an access request to the data access server and using the data access server for data saving,
wherein the data access server comprises:
a request reception section that receives the access request from the data file server;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section of the physical storage; and
a result transmission section that transmits the result of access by the access section to the data file server,
wherein the association table management section searches through logical blocks assigned respective physical blocks for a logical block for which no access request is made within a predetermined period, releases the physical block assigned to the logical block from the association with the logical block and includes the physical block in unused physical block.

2. The data file system according to claim 1, wherein the data file server comprises an all-used-block-access request section that makes access requests to all the logical blocks used by the data file server within the predetermined period to the data access server.

3. A data file system comprising:
a data access server that has a physical storage for storing data and accesses the physical storage in response to an access request; and
a data file server that performs data filing by transmitting an access request to the data access server and using the data access server for data saving,
wherein the data access server comprises:
a request reception section that receives the access request from the data file server;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
wherein the data file server comprises a discrimination information transmission section that transmits, to the data access server, discrimination information that discriminates between logical blocks being used by the data file server and unused logical blocks of all the logical blocks, and
wherein the association table management section searches through logical blocks assigned respective physical blocks for an unused logical block based on the discrimination information transmitted from the data file server, releases the physical block assigned to the unused logical block from the association with the logical block and includes the physical block in unused physical block.

4. A data access server that has a physical storage for storing data and accesses the physical storage in response to an access request, comprising:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
wherein the association table management section searches through logical blocks assigned respective physical blocks for a logical block for which no access request is made within a predetermined period, releases the physical block assigned to the logical block from the association with the logical block and includes the physical block in unused physical block.

5. A data access server that has a physical storage for storing data and accesses the physical storage in response to an access request, comprising:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
wherein the association table management section searches through logical blocks assigned respective physical blocks for an unused logical block based on discrimination information that is transmitted from the data file server and discriminates between logical blocks being used by the data file server and unused logical blocks of all the logical blocks, releases the physical block assigned to the unused logical block from the association with the logical block and includes the physical block in unused physical block.

6. A data access program storage medium that stores a data access program that runs in an information processing device to make the information processing device operate as a data access server which accesses a physical storage in response to an access request, the information processing device having the physical storage for storing data and allowing a program to run therein,
wherein the data access program storage medium stores a data access program that makes the information processing device operate as a data access server comprising:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
wherein the association table management section searches through logical blocks assigned respective physical blocks for a logical block for which no access request is made within a predetermined period, releases the physical block assigned to the logical block from the association with the logical block and includes the physical block in unused physical block.

7. A data access program storage medium that stores a data access program that runs in an information processing device to make the information processing device operate as a data access server which accesses a physical storage in response to an access request, the information processing device having the physical storage for storing data and allowing a program to run therein,
wherein the data access program storage medium stores a data access program that makes the information processing device operate as a data access server comprising:
a request reception section that receives the access request from a data file server that performs data filing;
an association table management section that has an association table describing an association between a plurality of physical blocks, which are storage blocks resulting from dividing the physical storage, and logical blocks recognized as storage blocks by the data file server and, when the access request is made by the data file server, if no physical block is assigned to the logical block to be accessed, assigns one of unused physical blocks to the logical block to be accessed;
a block conversion section that converts the logical block to be accessed into a physical block by referring to the association table when the access request is made by the data file server;
an access section that accesses the physical block provided by the block conversion section, of the physical storage; and
a result transmission section that transmits the result of access by the access section to the data file server,
wherein the association table management section searches through logical blocks assigned respective physical blocks for an unused logical block based on discrimination information that is transmitted from the data file server and discriminates between logical blocks being used by the data file server and unused logical blocks of all the logical blocks, releases the physical block assigned to the unused logical block from the association with the logical block and includes the physical block in unused physical block.
